(19) United States
(12) Patent Application Publication
(10) Pub. No.: US 2006/0154674 A1
(43) Pub. Date: Jul. 13, 2006

(54) Mobile communication device having geographical device setting control and method of operation thereof

(75) Inventors: Assaf Landschaft, Munich (DE); Gal Wohlstadter, Munich (DE); Gil Wohlstadter, Munich (DE)

Correspondence Address: HITT GAINES P.C., P.O. BOX 832570, RICHARDSON, TX, 75083, US

(73) Assignee: Agere Systems Incorporated, Allentown, PA (US)

(21) Appl. No.: 11/032,719

(22) Filed: Jan. 11, 2005

(51) Int. Cl. H04Q 7/20

(52) U.S. Cl. 455/456.6; 455/456.1

(57) ABSTRACT

A mobile communication device and a method of controlling mobile communication device settings. In one embodiment, the device includes: (1) a memory unit configured to store device settings, (2) a position indicator coupled to the memory unit and configured to determine a geographical position of the device and (3) a controller coupled to the memory unit and the position indicator and configured automatically to activate at least one of the device settings depending on the geographical position.

### TECHNICAL FIELD OF THE INVENTION

The present invention is directed, in general, to geographical localization, and more particularly to a mobile communication device having device settings that are automatically activated based upon the geographical position of the device.

### BACKGROUND OF THE INVENTION

The ongoing development of mobile communication devices provides the user with an increasing number of operation options or settings, such as the type of alert for an incoming call or message, the ringtone, the ring volume, or whether an integrated vibrator is activated.

Typically the user wants to change one or more of these settings when moving from one environment to another, such as for example from an indoor to an outdoor environment, or when entering a church, theatre or a meeting room.

Manually changing each setting is very inconvenient, since menus are frequently required to be navigated to reach the setting(s) to be changed. European Patent Application Serial No. 611070A describes a mobile telephone that is configured to store telephone settings in groups or profiles so that the user can switch several settings at a time by a single operation. Unfortunately, the need to manually select and activate a profile including certain device settings remains.

Therefore, what is needed in the art is further improvement in the approach to personalize and adjust the settings of a mobile communication device. What is further needed in the art is an automatic way to adjust mobile communication device settings.

### SUMMARY OF THE INVENTION

To address the above-discussed deficiencies of the prior art, the present invention provides, in one aspect, a mobile communication device. In one embodiment, the device includes: (1) a memory unit configured to store device settings, (2) a position indicator coupled to the memory unit and configured to determine a geographical position of the device and (3) a controller coupled to the memory unit and the position indicator and configured automatically to activate at least one of the device settings depending on the geographical position.

In another aspect, the present invention provides a method of controlling mobile communication device settings. In one embodiment, the method includes: (1) storing the device settings in a memory unit, (2) determining a geographical position of the device and (3) automatically activating at least one of the device settings depending on the geographical position.

The foregoing has outlined preferred and alternative features of the present invention so that those skilled in the art may better understand the detailed description of the present invention that follows. Additional features of the present invention will be described hereinafter that form the subject of the claims of the present invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates a schematic view of one embodiment of a mobile communication device having a GPS receiver constructed according to the principles of the present invention;

FIG. 2 illustrates components of one embodiment of a mobile communication device having a GPS receiver and constructed according to the principles of the present invention;

FIG. 3 schematically illustrates a circular geographical area for which certain device settings may be stored;

FIG. 4 schematically illustrates a rectangular geographical area for which certain device settings may be stored; and

FIG. 5 schematically illustrates two geographical areas having an overlapping region.

### DETAILED DESCRIPTION

As stated above, one aspect of the present invention introduces a mobile communication device, in particular a mobile telephone, a personal digital assistant (PDA) or a mobile digital assistant (MDA). The device includes at least a memory unit configured to store device settings, a position indicator coupled to the memory unit and configured to determine a geographical position of the device and a controller coupled to the memory unit and the position indicator and configured automatically to activate at least one of the device settings depending on the geographical position. The present invention applies to conventional and later-developed mobile telephones, PDA- or MDA-style devices or other mobile communication devices.

The location of most environments, such as a church, meeting room, theatre or park, can be defined according to geographical characteristics. By automatically activating stored device settings depending on the geographical position of the device, the user no longer needs to make manual adjustments when entering a particular environment. For example, the user does not have to remember to make the telephone silent when entering a cinema or a meeting room.

The stored setting that is automatically activated may be, for example, a ring tone, vibrator setting or both, since these settings are the most frequent to change in certain environments. Of course, other settings are within the broad scope of the present invention. So, for example, in a meeting room, church or a theatre, a user typically wants to prevent a loud ringing tone but wants to activate an integrated vibrator instead, in a park on the other hand the user typically wants an increased ringing volume due to background noise.

Since usually more than one setting, such as the type of alert for an incoming call, ringing tone, ringing volume, alert tone for incoming short messages (SMS) or vibrator mode, shall be changed when entering certain environments, a user-definable profile with a plurality of device settings may be activated.

The position indicator of the mobile communication device may include a GPS (Global Positioning System), Galileo or other satellite-based receiver (GPS will be used as a generic term). With a GPS receiver very accurate position information can be received from GPS satellites. For this purpose there are at least three satellites available to the receiver. Typically, though, a GPS receiver integrated in a mobile communication device does not contain a precise atomic clock. Therefore, the signal from a fourth satellite usually is used to compensate an error in the receiver's clock.

The high accuracy of GPS localization allows detection whether the device is located in a specific room of a building. Since GPS also delivers altitude information even different floors of a multistory building can be separated. This for example allows detection whether the device is located in the meeting room, in the own office or in the kitchen of a user's company, even if two of these rooms are located at the same spot on different floors.

For certain applications, position information of less accuracy may suffice (for example for deciding whether the user is at home or at work). For such applications, the present invention encompasses an alternative position indicator, which includes an information circuit configured to determine cell information from a cellular network and a position circuit configured to determine the geographical position from the cell information.

The geographical position associated with individual cells may be stored in a memory unit of the device in the form of a reference list or may be retrieved from the provider. The accuracy of localization via cell information naturally depends on the cell density, but is generally less accurate than GPS. But since it is easier and cheaper to implement into a mobile communication device than a GPS receiver, it is advantageous for certain applications.

For defining a geographical area and at least one associated device setting to be activated when the device enters this area, the device may include a user interface to provide user input data. The user interface may, for example, include a keypad and a display controlled by a software stored in the memory unit of the device. The user input data may be stored in the device in a user-defined reference list assigning device settings to geographical areas.

The geographical area to be defined may be described by a small number of parameters. For this purpose, for example, a circular or rectangular region may be especially suitable, wherein a circular region may be defined by entering the geographical position of its center point and the length of its radius. A rectangular region may be defined by entering the geographical positions of two diagonally opposite corner points.

A geographical position may be entered by providing coordinate values representing the geographical position via the keypad of the mobile communication device. An especially easy way to enter a geographical position is to move the device to the desired position and to define the current position, which can be automatically determined via the position indicator, as the geographical position.

So when entering, e.g., a cinema or any other special environment with an inventive device for the first time, the user may select an appropriate profile including certain device settings and associate this profile with the current geographical position of the device. In this manner, a certain self-learning effect of the device is achieved without having to provide geographical position coordinates manually.

The device may further be provided with a timer for automatically determining the geographical position of the device in selectable time intervals, so that the device settings can be adjusted automatically when the current geographical position of the device matches a user-defined geographical area stored in the memory unit of the device.

The device may therefore further include position detection circuit configured to detect when the determined geographical position of the device lies within a geographical area stored in the user-defined reference list. On detection, the at least one device setting associated with the geographical area is automatically activated.

The current device settings may be stored on entering a geographical area, perhaps in the user-defined reference list, so the settings to which the device was set prior to an automatic adjustment are not lost. The settings may then be re-activated when leaving the geographical area.

For the case that two or more geographical areas with different associated device settings entered by the user have overlapping regions, the device may be configured to automatically detect such overlapping regions and to prompt the user for entering the desired device settings for the detected overlapping regions. The device settings defined for the detected overlapping regions can also be stored in the user-defined reference list.

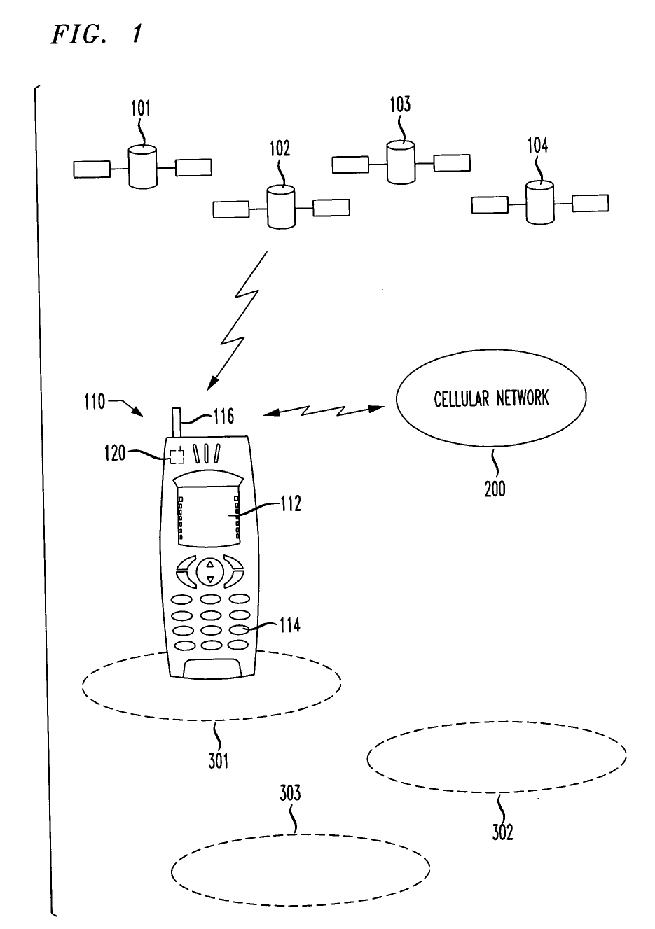

Having described various aspects of the present invention in general, reference is now made to FIG. 1 which shows a mobile communication device 110 equipped with a GPS receiver 120. The geographical position of the mobile communication device 110 is determined by receiving data from four GPS satellites 101, 102, 103, 104. From this data, the GPS receiver 120 deduces its exact distance from each GPS satellite 101, 102, 103, 104, as well as the geographic position of each GPS satellite 101, 102, 103, 104. The distance from each GPS satellite 101, 102, 103, 104 is determined by the time the signal is received. For this purpose the satellite signal includes the time at which it was sent. By comparing that to the receiver clock, the time delay and hence the distance can be determined. The signals from four satellites 101, 102, 103, 104 may be employed to compensate for errors in the clock of the GPS receiver 120. By evaluating the deduced satellite distance and position data, the GPS receiver 120 obtains an accurate information of its own geographical position, including altitude, as well as a precise clock update.

In the embodiment of FIG. 1, one common antenna 116 is used for the GPS receiver 120 and also for the communication transceiver for connecting to a cellular network 200.

The illustrated embodiment of the mobile communication device 110 is configured to activate a pre-defined device setting such as ringing tone or vibration alarm associated with a geographical area 301, 302, 303 in response to detecting that the mobile communication device 110 has entered the according area 301, 302, 303. For input of the necessary user data the mobile communication device 110 is provided with a keypad 114 and a display 112.

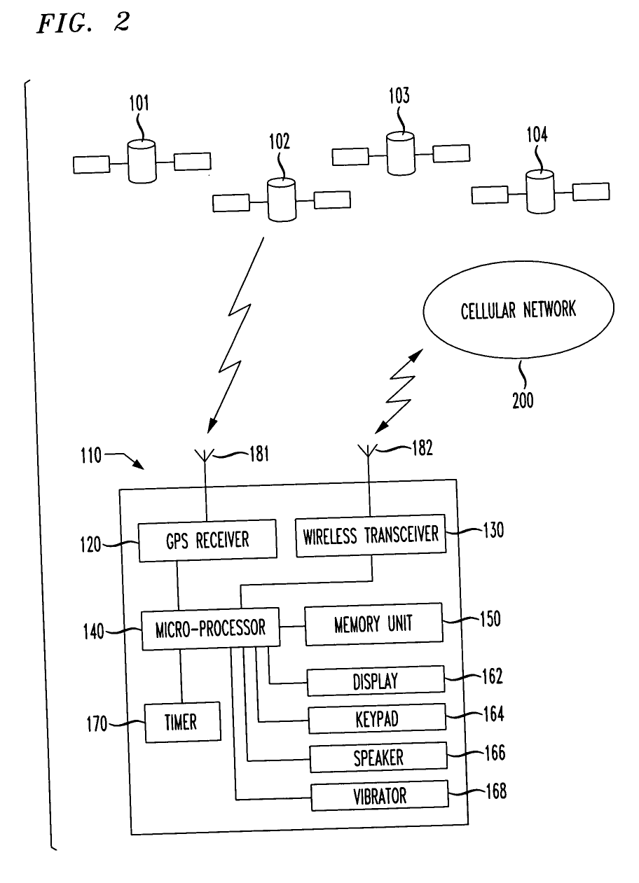

Turning now to FIG. 2, illustrated are representative components of one embodiment of an inventive mobile communication device 110 having a GPS receiver 120. In this embodiment the GPS receiver 120 and the communication transceiver 130 are provided with separate antennas 181, 182, respectively.

Similar to the embodiment shown in FIG. 1, the GPS receiver 120 is configured to determine the geographical position of the mobile communication device by receiving data from four GPS satellites 101, 102, 103, 104, and the communication transceiver 130 is configured to communicate with a cellular network 200.

In the illustrated embodiment of the memory unit 150, software is stored and retrieved for execution by a microprocessor 140. The software is configured to activate at least one device setting depending on the geographical position of the device determined by means of the GPS receiver 120. For this purpose, a user-defined reference list (not shown) may be stored in the memory unit 150 assigning certain device settings or profiles containing several device settings to certain geographical areas. By way of the device settings, the operation of the mobile communication device 110 is defined. The device settings may, for example, include the type of ringing tone or the ringing volume which is provided via an integrated speaker 166 or whether an integrated vibrator 168 is activated in the event of an incoming call. For input of user data, the mobile communication device 110 is provided with a display 162 and a keypad 164. The associated device setting is activated in response to detecting that the mobile communication device has entered a geographical area stored in the user-defined reference list. To regularly check whether the mobile communication device has entered such area, the illustrated embodiment of the mobile communication device 110 is provided with a timer 170 by which a determination of the geographical position of the device is achieved in selectable time intervals.

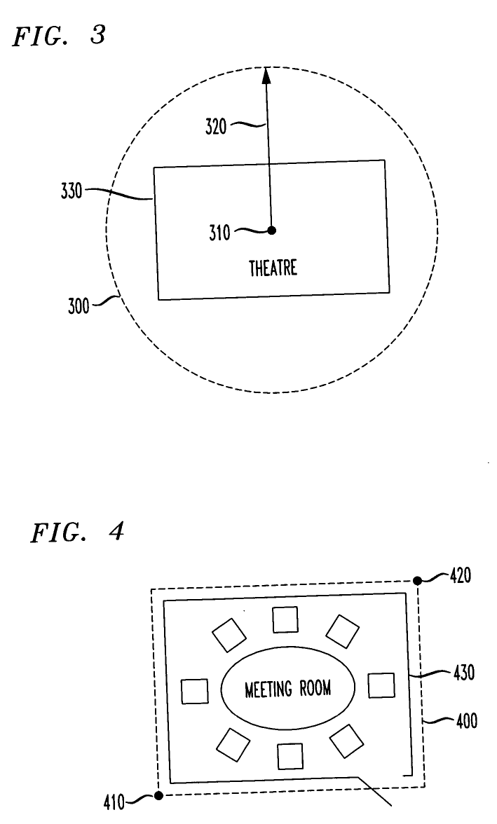

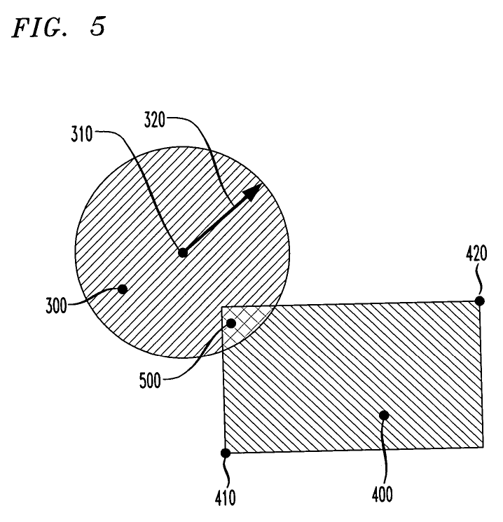

Turning now to FIGS. 3 and 4, illustrated are examples of parameters for defining a geographical area to which at least one device setting is associated. FIG. 3 shows in particular a circular area 300, which is defined by the geographical position of its center point 310 and by the length of its radius 320. The exemplary geographical area 300 shown in FIG. 3 completely includes the building of a theatre 330.

FIG. 4 particularly shows a rectangular area 400, which is defined by the geographical positions of two diagonally opposite corner points 410, 420. The area 400 in this example matches with the area of a meeting room 430. If meeting room 430 is located in a multistory building the altitude or an altitude range can be stored as a further parameter defining the geographical area.

Turning now to FIG. 5, illustrated are two geographical areas 300 and 400, defined by a center point 310 and a radius 320 and by corner points 410, 420 respectively. In this example the two areas 300, 400 have an overlap thereby forming an overlapping region 500. The mobile communication device 110 may be configured to calculate such overlapping regions automatically from the area parameters provided by the user. When such overlapping region 500 is detected and the areas 300 and 400 are associated with different device settings, the user may be prompted to define the device settings for overlapping region 500.

Although the present invention has been described in detail, those skilled in the art should understand that they can make various changes, substitutions and alterations herein without departing from the spirit and scope of the present invention in its broadest form.

What is claimed is:

1. A mobile communication device, comprising:
a memory unit configured to store device settings;
a position indicator coupled to said memory unit and configured to determine a geographical position of the device; and
a controller coupled to said memory unit and said position indicator and configured automatically to activate at least one of said device settings depending on said geographical position.

2. The device as recited in claim 1 wherein said device is selected from the group consisting of:
a mobile telephone,
a personal digital assistant, and
a mobile digital assistant.

3. The device as recited in claim 1 wherein said device settings comprise a selected one of:
a ring tone setting, and
a vibrator setting.

4. The device as recited in claim 1 wherein said device settings are associated with a particular user-definable profile.

5. The device as recited in claim 1 wherein said position indicator comprises a GPS (Global Positioning System) receiver.

6. The device as recited in claim 1 wherein said position indicator comprises:
an information circuit configured to determine cell information from a cellular network; and
a position circuit configured to determine said geographical position from said cell information.

7. The device as recited in claim 1 wherein said position indicator is further configured to determine an altitude of said device.

8. The device as recited in claim 1 further comprising a user interface configured to receive input data defining a geographical area and at least one of said device settings.

9. The device as recited in claim 8 wherein said geographical area is a circular region defined by a center point and a radius.

10. The device as recited in claim 8 wherein said geographical area is a rectangular region defined by diagonally opposite corner points.

11. The device as recited in claim 8 wherein said input data causes said device settings to be associated with geographical areas.

12. The device as recited in claim 1 further comprising a timer configured automatically to determine said geographical position at selectable time intervals.

13. The device as recited in claim 1 further comprising a detection circuit configured to detect when said geographical position of said device lies within at least one of said geographical areas, said controller automatically activating said least one of said device settings based thereon.

14. The device as recited in claim 13 wherein said controller is further configured to store current device settings for reactivation upon leaving said geographical area.

15. The device as recited in claim 11 wherein said controller automatically detects an overlapping region and stores device settings associated with said overlapping region in said user-defined reference list.

16. A method of controlling mobile communication device settings, comprising:
storing said device settings in a memory unit;
determining a geographical position of the device; and
automatically activating at least one of said device settings depending on said geographical position.

17. The method as recited in claim 16 wherein said device is selected from the group consisting of:
a mobile telephone,
a personal digital assistant, and
a mobile digital assistant.

18. The method as recited in claim 16 wherein said device settings comprise a selected one of:
a ring tone setting, and
a vibrator setting.

19. The method as recited in claim 16 wherein said device settings are associated with a particular user-definable profile.

20. The method as recited in claim 16 wherein said determining is carried out by a GPS (Global Positioning System) receiver.

21. The method as recited in claim 16 wherein said determining comprises:
determining cell information from a cellular network; and
determining said geographical position from said cell information.

22. The method as recited in claim 16 wherein said determining comprises determining an altitude of said device.

23. The method as recited in claim 16 further comprising receiving input data defining a geographical area and at least one of said device settings.

24. The method as recited in claim 23 wherein said geographical area is a circular region defined by a center point and a radius.

25. The method as recited in claim 23 wherein said geographical area is a rectangular region defined by diagonally opposite corner points.

26. The method as recited in claim 23 further comprising causing said device settings to be associated with geographical areas.

27. The method as recited in claim 16 further comprising determining said geographical position at selectable time intervals.

28. The method as recited in claim 15 further comprising:
detecting when said geographical position of said device lies within at least one of said geographical areas; and
automatically activating said least one of said device settings based thereon.

29. The method as recited in claim 28 further comprising further storing current device settings for reactivation upon leaving said geographical area.

30. The method as recited in claim 26 further comprising:
automatically detecting an overlapping region; and
storing device settings associated with said overlapping region in said user-defined reference list.
